(19) United States
(12) Patent Application Publication
(10) Pub. No.: US 2026/0012761 A1
(43) Pub. Date: Jan. 8, 2026

(54) ELECTRONIC DEVICE, METHOD, AND NON-TRANSITORY COMPUTER READABLE RECORDING MEDIUM FOR MANAGING IDENTITY INFORMATION

(71) Applicant: Samsung Electronics Co., Ltd., Suwon-si (KR)

(72) Inventors: Seongjoon PARK, Suwon-si (KR); Mingu KANG, Suwon-si (KR); Suhyun KIM, Suwon-si (KR); Junhwan AN, Suwon-si (KR); Gyujin LEE, Suwon-si (KR)

(21) Appl. No.: 19/176,667

(22) Filed: Apr. 11, 2025

Related U.S. Application Data
(63) Continuation of application No. PCT/KR2025/004019, filed on Mar. 28, 2025.

(30) Foreign Application Priority Data
Jul. 5, 2024 (KR) 10-2024-0089263
Jul. 26, 2024 (KR) 10-2024-0099195

(51) Int. Cl. H04W 4/23; H04W 12/0431; H04W 12/79

(52) U.S. Cl. CPC H04W 4/23; H04W 12/0431; H04W 12/79

(57) ABSTRACT

An electronic device is provided. The electronic device includes communication circuitry, at least one processor including processing circuitry, and memory including one or more storage mediums, storing instructions, wherein the instructions that, when executed by the at least one processor individually or collectively, cause the electronic device to receive, via the communication circuitry, an advertising packet advertised from an external electronic device, determine, based on a first list of identity resolving keys (IRKs) of other electronic devices whether a resolvable private address (RPA) of the external electronic device in the advertising packet is resolved, and based on determining that the RPA of the external electronic device is not resolved, request, from the external electronic device, via the communication circuitry, a version of a second list of IRKs.

### CROSS-REFERENCE TO RELATED APPLICATION(S)

This application is a continuation application, claiming priority under 35 U.S.C. § 365 (c), of an International application No. PCT/KR2025/004019, filed on Mar. 28, 2025, which is based on and claims the benefit of a Korean patent application number 10-2024-0089263, filed on Jul. 5, 2024, in the Korean Intellectual Property Office, and of a Korean patent application number 10-2024-0099195, filed on Jul. 26, 2024, in the Korean Intellectual Property Office, the disclosure of each of which is incorporated by reference herein in its entirety.

### TECHNICAL FIELD

The disclosure relates to an electronic device, a method, and a non-transitory computer readable recording medium for managing identity information.

### BACKGROUND ART

With a recent development of information and communication technology, various wireless communication technologies and various services have been developed. In particular, one of short-range communication methods, a Bluetooth method, as an example, Bluetooth low energy (BLE) method is actively used, and in the BLE method, low-capacity data may be transmitted and/or received at low power in a frequency band of about 2.4 GHZ.

In a wireless communication network, in case that a continuity service is provided, a plurality of electronic devices may be registered, by using the same account, and the plurality of electronic devices registered by using the same account may share information on the account. Therefore, in case that information on the account included in a received BLE advertising (ADV) packet is the same as information on the account of the electronic device stored in the electronic device, the electronic device receiving the BLE ADV packet including the information on the account may detect that the electronic device transmitting the BLE ADV packet is the electronic device registered by using the same account as the electronic device receiving the BLE ADV packet.

As such, in the current continuity service, the information on the account may broadcast by being included in the BLE ADV packet, and therefore, each of the plurality of electronic devices registered by using the same account may detect existence of external electronic devices registered by using the same account. However, in the current continuity service, a separate way to uniquely identify each of the plurality of electronic devices registered by using the same account is not provided.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer readable recording medium for managing identity information.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, at least one processor including processing circuitry, and memory, including one or more storage mediums storing instructions, wherein the instructions that, when executed by the at least one processor individually or collectively, cause the electronic device to receive, via the communication circuitry, an advertising packet advertised from an external electronic device, determine, based on a first list of identity resolving keys (IRKs) of other electronic devices, whether a resolvable private address (RPA) of the external electronic device in the advertising packet is resolved, and based on determining that the RPA of the external electronic device is not resolved, request, from the external electronic device, via the communication circuitry, a version of a second list of IRKs.

In accordance with another aspect of the disclosure, a method performed by an electronic device including communication circuitry is provided. The method includes receiving, via the communication circuitry, an advertising packet advertised from an external electronic device, determining, based on a first list of identity resolving keys (IRKs) of other electronic devices, whether a resolvable private address (RPA) of the external electronic device in the advertising packet is resolved, and based on determining that the RPA of the external electronic device is not resolved, requesting, from the external electronic device, via the communication circuitry, a version of a second list of IRKs.

In accordance with another aspect of the disclosure, one or more non-transitory computer-readable storage media storing one or more computer programs including computer-executable instructions that, when executed by at least one processor of an electronic device including communication circuitry individually or collectively, cause the electronic device to perform operations are provided. The operations include receiving, via the communication circuitry, an advertising packet advertised from an external electronic device, determining, based on a first list of identity resolving keys (IRKs) of other electronic devices, whether a resolvable private address (RPA) of the external electronic device in the advertising packet is resolved, and based on determining that the RPA of the external electronic device is not resolved, requesting, from the external electronic device, via the communication circuitry, a version of a second list of IRKs.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B are block diagrams of an electronic device according to various embodiments of the disclosure;

FIG. 3 is a flowchart indicating an operation in which an electronic device determines whether to update a resolving list according to an embodiment of the disclosure;

FIG. 4 is a flowchart indicating an operation in which an electronic device updates a resolving list according to an embodiment of the disclosure;

FIG. 5 is a flowchart indicating an operation in which an electronic device determines whether to update a resolving list according to an embodiment of the disclosure;

FIG. 6 is a flowchart indicating an operation in which an electronic device compares a version of a resolving list according to an embodiment of the disclosure;

FIG. 7A is a flowchart indicating an operation in which an electronic device updates a resolving list according to an embodiment of the disclosure;

FIG. 7B is a flowchart illustrating an operation in which an electronic device updates a resolving list according to an embodiment of the disclosure;

FIG. 8A is a diagram illustrating a user interface (UI) querying an update of a resolving list displayed by an electronic device according to an embodiment of the disclosure;

FIG. 8B is a diagram illustrating a UI querying whether to share information on a resolving list displayed by an electronic device according to an embodiment of the disclosure; and

FIG. 9 is a flowchart indicating an operation in which an electronic device updates a resolving list according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

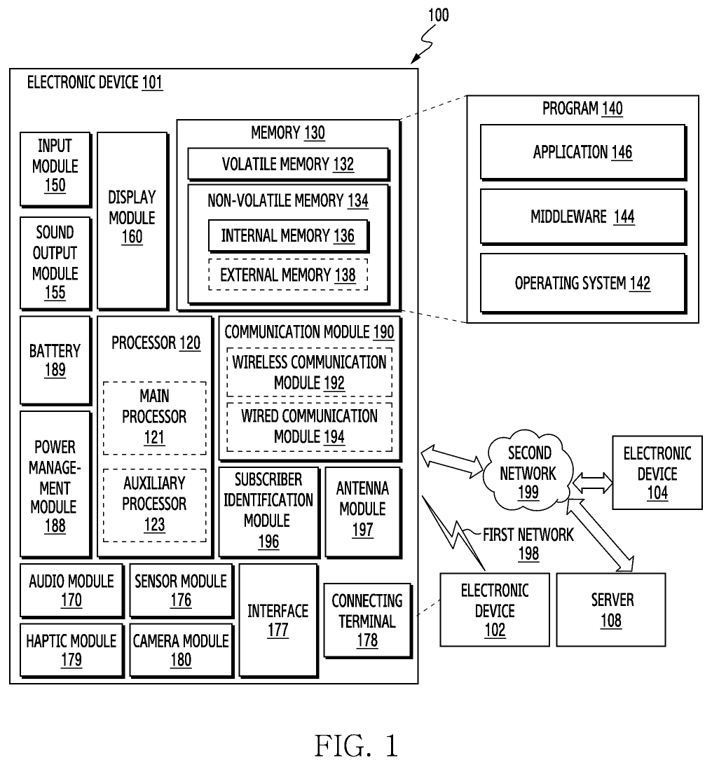

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

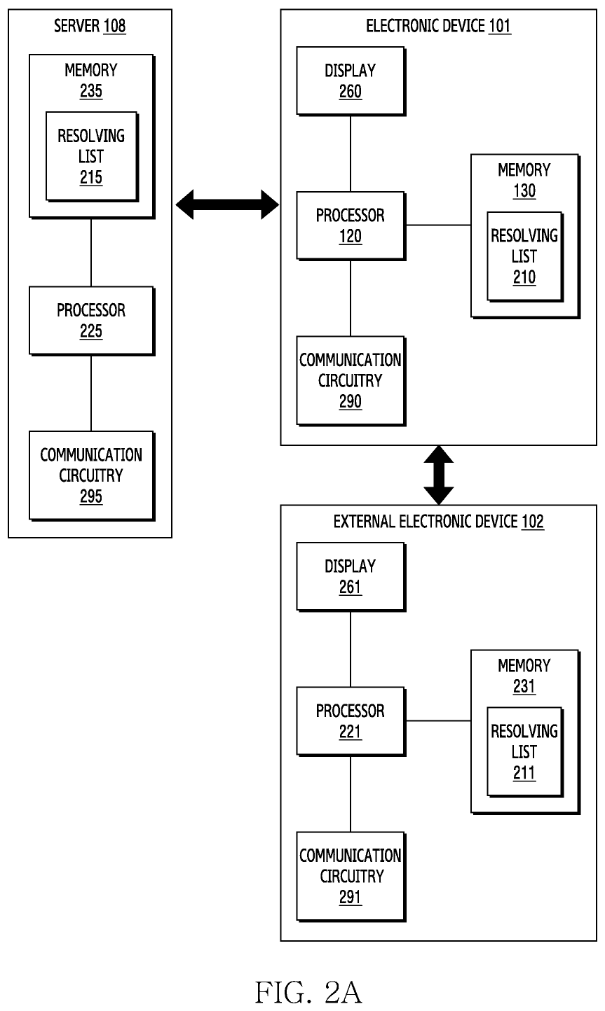

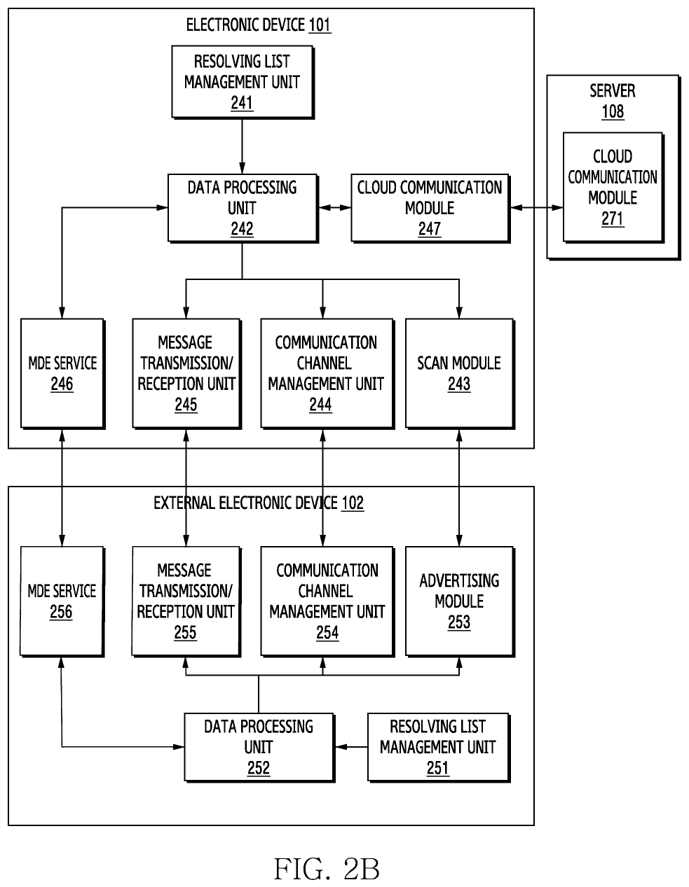

FIGS. 2A and 2B are block diagrams of an electronic device according to various embodiments of the disclosure.

Referring to FIG. 2A, an electronic device 101 may wirelessly communicate with the external electronic device 102 and/or the server 108. The electronic device 101 of FIG. 2A may correspond to the electronic device 101 of FIG. 1. The external electronic device 102 of FIG. 2A may correspond to the external electronic device 102 of FIG. 1. The server 108 of FIG. 2A may correspond to the server 108 of FIG. 1.

In an embodiment of the disclosure, the electronic device 101 may include a processor 120, memory 130, a display 260, and communication circuitry 290. In an embodiment of the disclosure, the memory 130 may include a resolving list 210. In an embodiment of the disclosure, the processor 120, the memory 130, the display 260, and the communication circuitry 290 of FIG. 2A may correspond to the processor 120, the memory 130, the display module 160, and the communication module 190 of FIG. 1, respectively.

In an embodiment of the disclosure, the processor 120 may manage the resolving list 210 stored in the memory 130.

In an embodiment of the disclosure, the communication circuitry 290 may include a communication circuitry (e.g., communication circuitry for a Bluetooth low energy (BLE) communication technique and/or a legacy Bluetooth communication technique) for wireless communication with the external electronic device 102 and communication circuitry (e.g., communication circuitry for a cellular communication technique and/or a Wi-Fi communication technique) for wireless communication with the server 108. However, it is not limited thereto. In an embodiment of the disclosure, in the communication circuitry 290, communication circuitry for wireless communication with the external electronic device 102 and communication circuitry for wireless communication with the server 108 may be the same.

Referring to FIG. 2B, the electronic device 101 may include a resolving list management unit 241, a data processing unit 242, a scan module 243, a communication channel management unit 244, a message transmission/reception unit 245, a multi-device experience (MDE) service 246, and a cloud communication module 247. In an embodiment of the disclosure, the resolving list management unit 241, the data processing unit 242, the scan module 243, the communication channel management unit 244, the message transmission/reception unit 245, the MDE service 246, and the cloud communication module 247 may be programs that may be executed by the processor 120. In an embodiment of the disclosure, communication between the scan module 243, the communication channel management unit 244, the message transmission/reception unit 245, and the MDE service 246 of the electronic device 101 and an advertising module 253, a communication channel management unit 254, a message transmission/reception unit 255, and an MDE service 256 of the external electronic device 102 may be performed via the communication circuitry 290 of the electronic device 101. In an embodiment of the disclosure, communication between the cloud communication module 247 of the electronic device 101 and a cloud communication module 271 of the server 108 may be performed via the communication circuitry 290 of the electronic device 101.

Operations described below may be performed by the electronic device 101 based on the processor 120 executing instructions included in the resolving list management unit 241, the data processing unit 242, the scan module 243, the communication channel management unit 244, the message transmission/reception unit 245, the MDE service 246, and/or the cloud communication module 247.

In an embodiment of the disclosure, the resolving list management unit 241 may manage the resolving list 210 of identity resolving keys (IRKs) of one or more electronic devices linked with a user account logged (or registered) in the electronic device 101. For example, the user account may be the same as or correspond to a user account used for the electronic device 101. For example, the user account may be the same as or correspond to a user account used for the external electronic device 102. For example, the user account may be a user account linked with the user account used for the external electronic device 102.

In an embodiment of the disclosure, the resolving list management unit 241 may update the resolving list 210 based on receiving a list of IRKs from the external electronic device 102 and/or the server 108. For example, the resolving list management unit 241 may delete a list of existing IRKs included in the resolving list 210 and add the list of received IRKs based on receiving the list of IRKs from the external electronic device 102 and/or the server 108. In an embodiment of the disclosure, the IRK included in the list of IRKs may be allocated or randomly generated by the electronic device that will use the IRK. In an embodiment of the disclosure, the IRK may be a bit sequence (e.g., 128 bits) of a designated length to generate a random address (or a resolvable private address (RPA)) of the electronic device. For example, the RPA may be used to protect or hide a real address (e.g., a medium access control (MAC) address) of the electronic device 101 and the external electronic device 102. In an embodiment of the disclosure, the RPA may be a 48-bit bit sequence in which a hash value and a prand are connected. In an embodiment of the disclosure, the prand may be a 24-bit random number. In an embodiment of the disclosure, the hash value may be a 24-bit bit sequence generated based on Equation 1 below.

$$hash = ah ( IRK , prand ) \qquad Equation 1$$

In Equation 1, ah( ) may be a function that generates the hash value based on the IRK and the prand. According to a calculation result of Equation 1, a hash having a 24-bit bit sequence may be generated.

In an embodiment of the disclosure, the resolving list management unit 241 may manage the resolving list 210, such as Table 1 below.

TABLE 1

| Device ID(identity) | IRK |
|---|---|
| ID 1 | 29AB . . . 47BC |
| ID 2 | FA23 . . . 58E1 |
| . . . | . . . |
| ID n | 7A5B . . . DD7A |

Referring to Table 1, the resolving list management unit 241 may manage the resolving list 210 by mapping device identity information (ID) and IRK. In an embodiment of the disclosure, the device identity information may be identity information (or fingerprint) of one or more electronic devices linked with the user account. In an embodiment of the disclosure, the electronic device linked with the user account may be referred to as a peer electronic device.

In an embodiment of the disclosure, the resolving list management unit 241 may manage version information of the resolving list 210. In an embodiment of the disclosure, the resolving list management unit 241 may manage (or allocate) the version information of the resolving list 210 based on an integer value. In an embodiment of the disclosure, the resolving list management unit 241 may allocate the version information of the resolving list 210 as a positive integer value. In an embodiment of the disclosure, the resolving list management unit 241 may manage (or allocate) the version information of the resolving list 210 in a bit sequence of a designated length (e.g., 32 bits).

In an embodiment of the disclosure, the data processing unit 242 may receive an advertising packet (or a BLE advertisement (BLE ADV) packet) via the scan module 243. In an embodiment of the disclosure, the data processing unit 242 may obtain, from the scan module 243, the advertising packet received by the scan module 243 via the communication circuitry 290 of the electronic device 101.

In an embodiment of the disclosure, the data processing unit 242 may process the advertising packet (or the BLE ADV packet) received via the scan module 243.

In an embodiment of the disclosure, the data processing unit 242 may identify the RPA of the external electronic device 102 included in the advertising packet. For example, the data processing unit 242 may identify the RPA of the external electronic device 102 included in the advertising packet based on the identity information included in the advertising packet indicating a fingerprint (or fingerprinting information) of the electronic device 101 (or the user account of the electronic device 101). For example, the data processing unit 242 may identify the RPA of the external electronic device 102 included in the advertising packet based on the identity information included in the advertising packet being included in a filter allow list of the electronic device 101 (or the user account of the electronic device 101).

In an embodiment of the disclosure, the data processing unit 242 may resolve the RPA of the external electronic device 102 based on the IRKs included in the resolving list 210. For example, the data processing unit 242 may, based on Equation 1, obtain hash values for the prand of the RPA of the external electronic device 102 based on the IRK included in the resolving list 210. For example, the data processing unit 242 may compare the hash values for the prand of the RPA of the external electronic device 102 derived based on the IRK included in the resolving list 210 with a hash value corresponding to the hash value of the RPA of the external electronic device 102. For example, the data processing unit 242 may identify whether there is a hash value corresponding to the hash value of the RPA of the external electronic device 102 among the hash values for the prand of the RPA of the external electronic device 102 derived based on the IRK included in the resolving list 210.

For example, the data processing unit 242 may determine that the RPA of the external electronic device 102 is resolved based on identifying the hash value corresponding to the hash value of the RPA of the external electronic device 102 among the hash values for the prand of the RPA of the external electronic device 102 derived based on the IRK included in the resolving list 210.

In an embodiment of the disclosure, the data processing unit 242 may identify a device ID (or an electronic device) mapped to the IRK for generating the hash value corresponding to the hash value of the RPA of the external electronic device 102. In an embodiment of the disclosure, the data processing unit 242 may identify the electronic device mapped to the IRK for generating the hash value corresponding to the hash value of the RPA of the external electronic device 102 as an electronic device that has transmitted the advertising packet.

In an embodiment of the disclosure, the data processing unit 242 may transmit an advertising event to the MDE service 246 based on the RPA of the external electronic device 102 being resolved. In an embodiment of the disclosure, the data processing unit 242 may transmit a content of the advertising packet to the MDE service 246 based on the RPA of the external electronic device 102 being resolved. In an embodiment of the disclosure, based on the data processing unit 242 transmitting the content of the advertising packet to the MDE service 246, the electronic device 101 may provide a continuation service, a sharing service, and/or a quick sharing service to the user.

In an embodiment of the disclosure, the data processing unit 242 may request the communication channel management unit 244 to establish a (temporary) communication channel with the external electronic device 102 based on the RPA of the external electronic device 102 not being resolved. In an embodiment of the disclosure, the data processing unit 242 may transmit information (e.g., the RPA of the external electronic device 102) for establishing the (temporary) communication channel with the external electronic device 102 to the communication channel management unit 244. In an embodiment of the disclosure, the data processing unit 242 may request the communication channel management unit 244 to establish the (temporary) communication channel with the external electronic device 102 based on the communication circuitry 290 of the electronic device 101.

In an embodiment of the disclosure, the data processing unit 242 may decrypt a payload of the advertising packet from the external electronic device 102 based on the RPA of the external electronic device 102 not being resolved. In an embodiment of the disclosure, the data processing unit 242 may determine whether a decrypted payload includes data (or a designated field) with a designated format. For example, the data processing unit 242 may determine whether the decrypted payload includes an advertisement address (AdvA) field and/or an advertisement data (AdvData) field. For example, the data processing unit 242 may determine whether the AdvData field of the decrypted payload includes at least one advertising data (AD) element. In an embodiment of the disclosure, the data processing unit 242 may determine that the decryption of the payload is successful based on determining that the decrypted payload includes the data (or the designated field) with the designated format. In an embodiment of the disclosure, the data processing unit 242 may determine that decryption of the payload has failed based on determining that the decrypted payload does not include the data (or the specified field) with the specified format.

In an embodiment of the disclosure, the data processing unit 242 may request the communication channel management unit 244 to establish the (temporary) communication channel with the external electronic device 102 based on determining that the RPA of the external electronic device 102 is not resolved and that the decryption of the payload is successful. In an embodiment of the disclosure, the data processing unit 242 may filter the advertising packet from the external electronic device 102 based on determining that the RPA of the external electronic device 102 is not resolved and that the decryption of the payload has failed. For example, filtering the advertising packet from the external electronic device 102 may include discarding the advertising packet received from the external electronic device 102 without resolving the advertising packet received from the external electronic device 102. For example, filtering the advertising packet from the external electronic device 102 may include excluding identity information included in the advertising packet of the external electronic device 102 from a filter allow list. For example, the identity information may indicate a unique value (or fingerprint) generated for each user account. For example, the identity information may be included in the advertising packet.

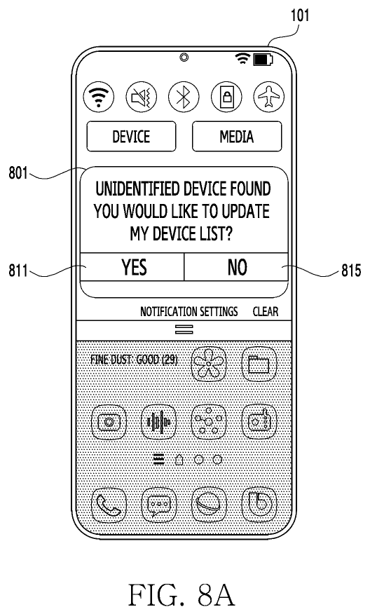

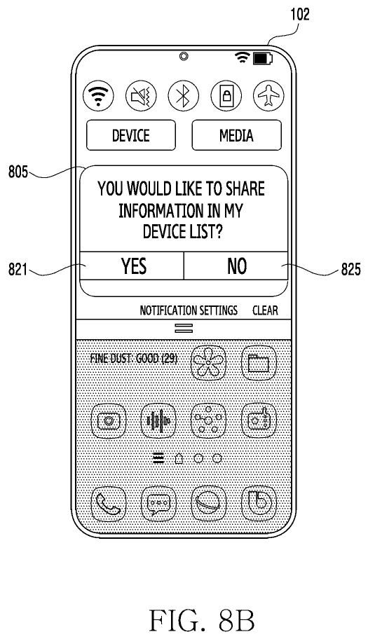

In an embodiment of the disclosure, the data processing unit 242 may display a user interface (UI) (e.g., UI of FIG. 8A) querying whether to update the resolving list 210 via the display 260 based on determining that the RPA of the external electronic device 102 is not resolved. In an embodiment of the disclosure, the data processing unit 242 may obtain a user input regarding a UI displayed based on determining that the RPA of the external electronic device 102 is not resolved. In an embodiment of the disclosure, the data processing unit 242 may request the communication channel management unit 244 to establish the (temporary) communication channel with the external electronic device 102 based on determining that the user input regarding the UI indicates update of the resolving list 210.

In an embodiment of the disclosure, the communication channel management unit 244 may manage generation and/or termination of a communication channel between the electronic device 101 and the external electronic device 102. For example, the communication channel management unit 244 may generate, maintain, and/or remove information for the communication channel between the electronic device 101 and the external electronic device 102. In an embodiment of the disclosure, the communication channel management unit 244 may manage, via the communication circuitry 290, the generation and/or the termination of the communication channel between the electronic device 101 and the external electronic device 102.

In an embodiment of the disclosure, the communication channel management unit 244 may establish the (temporary) communication channel between the electronic device 101 and the external electronic device 102 by transmitting information (e.g., the RPA of the external electronic device 102) for establishing the communication channel to the external electronic device 102. However, it is not limited thereto.

In an embodiment of the disclosure, the communication channel management unit 244 may determine whether the RPA of the external electronic device 102 is an RPA of the electronic device in which the (temporary) communication channel with the electronic device 101 is established within designated time (e.g., at least 10 minutes). In an embodiment of the disclosure, the communication channel management unit 244 may defer (or suspend) establishment of the (temporary) communication channel for the designated time based on determining that the RPA of the external electronic device 102 is not resolved and the RPA of the external electronic device 102 is the RPA of the electronic device 101 in which the (temporary) communication channel with the electronic device 101 is established within the designated time. However, it is not limited thereto. For example, the communication channel management unit 244 may defer (or suspend) the establishment of the (temporary) communication channel with the external electronic device 102 based on determining that the RPA of the external electronic device 102 is not resolved and the RPA of the external electronic device 102 is the RPA of the electronic device in which the (temporary) communication channel with the electronic device 101 is previously established.

For example, the (temporary) communication channel may be a communication channel based on a logical link control and adaption protocol (L2CAP) utilizing the RPA of the external electronic device 102. However, it is not limited thereto. In addition, the (temporary) communication channel may be a communication channel based on a communication protocol (e.g., Wi-Fi) other than BLE. For example, the communication channel management unit 244 may transmit information (e.g., Wi-Fi router information and/or allocated Internet protocol (IP) address) for establishing a communication channel of the communication protocol other than BLE included in the advertising packet transmitted by the external electronic device 102.

In an embodiment of the disclosure, the data processing unit 242 may request version information of a resolving list 211 from the external electronic device 102 via the message transmission/reception unit 245 based on the RPA of the external electronic device 102 not being resolved. In an embodiment of the disclosure, the data processing unit 242 may request, via the message transmission/reception unit 245, the version information of the resolving list 211 from the external electronic device 102 by using the (temporary) communication channel.

In an embodiment of the disclosure, the data processing unit 242 may receive, via the message transmission/reception unit 245, the version information of the resolving list 211 stored in the external electronic device 102 from the external electronic device 102.

In an embodiment of the disclosure, the data processing unit 242 may compare the version information of the resolving list 211 from the external electronic device 102 with the version information of the resolving list 210 stored in the electronic device 101.

In an embodiment of the disclosure, the data processing unit 242 may discard the advertising packet received from the external electronic device 102 based on the fact that the version information of the resolving list 210 stored in the electronic device 101 indicates newer version information than the version information of the resolving list 211 from the external electronic device 102. In an embodiment of the disclosure, the data processing unit 242 may filter the advertising packet from the external electronic device 102 based on the fact that the version information of the resolving list 210 indicates newer version information than the version information of the resolving list 211. For example, filtering the advertising packet from the external electronic device 102 may include discarding the advertising packet received from the external electronic device 102 without resolving the advertising packet received from the external electronic device 102. For example, filtering the advertising packet from the external electronic device 102 may include excluding the identity information included in the advertising packet of the external electronic device 102 from the filter allow list.

In an embodiment of the disclosure, the data processing unit 242 may request a resolving list of newer version information based on the fact that the version information of the resolving list 211 from the external electronic device 102 indicates newer version information than the version information of the resolving list 210 stored in the electronic device 101. In an embodiment of the disclosure, the request for the resolving list of newer version information may include the version information of the resolving list 211 of the external electronic device 102.

In an embodiment of the disclosure, the data processing unit 242 may request the server 108 a resolving list 215 of newer version information via the cloud communication module 247 based on the fact that the version information of the resolving list 211 from the external electronic device 102 indicates newer version information than the version information of the resolving list 210 stored in the electronic device 101. However, it is not limited thereto. For example, the data processing unit 242 may request the resolving list 211 from the external electronic device 102 via the message transmission/reception unit 245 based on the fact that the version information of the resolving list 211 from the external electronic device 102 indicates newer version information than the version information of the resolving list 210 stored in the electronic device 101.

In an embodiment of the disclosure, the data processing unit 242 may receive, via the cloud communication module 247, the resolving list 215 of newer version information from the server 108. However, it is not limited thereto. In an embodiment of the disclosure, the data processing unit 242 may receive, via the cloud communication module 247, from the server 108, the resolving list 215 of version information corresponding to the version information of the resolving list 211 of the external electronic device 102.

In an embodiment of the disclosure, the data processing unit 242 may update, via the resolving list management unit 241, the resolving list 210 based on the resolving list 215 of newer version information from the server 108. In an embodiment of the disclosure, the data processing unit 242 may replace, via the resolving list management unit 241, the resolving list 210 with the resolving list 215 of newer version information from the server 108.

In an embodiment of the disclosure, the data processing unit 242 may resolve an RPA included in a new advertising packet advertised from the external electronic device 102 based on updating the resolving list 210. However, it is not limited thereto. In an embodiment of the disclosure, the data processing unit 242 may resolve again the RPA included in the advertising packet (or an advertising packet cached in the memory 130) (or an advertising packet temporarily stored in the memory 130) previously advertised from the external electronic device 102 based on updating the resolving list 210. For example, the data processing unit 242 may resolve again the RPA included in the advertising packet obtained before (or before establishment of a temporary communication channel) the update of the resolving list 210 based on updating the resolving list 210.

In an embodiment of the disclosure, the MDE service 246 may include notifying, indicating, or guiding a state of the electronic device 101 to one or more devices (e.g., the external electronic device 102) around the electronic device 101.

In an embodiment of the disclosure, the MDE service 246 may include providing a user environment in which at least a portion of a capability of the electronic device 101 and at least a portion of a capability of the external electronic device 102 are integrated. In an embodiment of the disclosure, the MDE service 246 may include executing a software application executed in the electronic device 101 in the external electronic device 102 and maintaining an execution state of the software application in the electronic device 101 in the external electronic device 102. In an embodiment of the disclosure, the MDE service 246 may be referred to as a continuation service. However, it is not limited thereto. In an embodiment of the disclosure, the MDE service 246 may include transmitting information on a content in the electronic device 101 to one or more devices (e.g., the external electronic device 102) around the electronic device 101. For example, the MDE service 246 may be referred to as a sharing service or a quick sharing service in terms of sharing the content with one or more devices. For example, the MDE service 246 may include pasting text, an image, and/or a file copied (or stored) from the electronic device 101 to clipboard in the external electronic device 102. For example, the MDE service 246 may include transmitting an input for an input module (e.g., the input module 155 of FIG. 1) connected to the electronic device 101 to the external electronic device 102.

According to an embodiment of the disclosure, the data processing unit 242 may request the server 108 for the resolving list 215 of newer version information via the cloud communication module 247 based on the RPA of the external electronic device 102 not being resolved. For example, based on the RPA of the external electronic device 102 not being resolved, the data processing unit 242 may request the server 108 for the resolving list 215 of newer version information via the cloud communication module 247 without requesting the version information of the resolving list 211 from the external electronic device 102.

According to an embodiment of the disclosure, the advertising packet transmitted by the external electronic device 102 may include the version information of the resolving list 211. In an embodiment of the disclosure, the data processing unit 242 may request the server 108 and/or the external electronic device 102 for the resolving list of newer version information based on the fact that the RPA of the external electronic device 102 is not resolved and the version information of the resolving list 211 included in the advertising packet from the external electronic device 102 indicates newer version information than the version information of the resolving list 210 stored in the electronic device 101. However, it is not limited thereto. In an embodiment of the disclosure, the data processing unit 242 may request the server 108 and/or the external electronic device 102 for the resolving list of newer version information based on the fact that the version information of the resolving list 211 included in the advertising packet from the external electronic device 102 indicates newer version information than the version information of the resolving list 210 stored in the electronic device 101, without resolving the RPA of the external electronic device 102.

According to an embodiment of the disclosure, the advertising packet transmitted by the external electronic device 102 may include a field indicating whether the version information of the resolving list 211 may be transmitted. For example, the data processing unit 242 may request the server 108 for the resolving list 215 of newer version information via the cloud communication module 247 without requesting the external electronic device 102 for the version information of the resolving list 211 based on the fact that the RPA of the external electronic device 102 is not resolved and the advertising packet from the external electronic device 102 indicates that transmission of the version information of the resolving list 211 is not possible.

Referring to FIG. 2A, the external electronic device 102 may include a processor 221, memory 231, a display 261, and communication circuitry 291. In an embodiment of the disclosure, the memory 231 may include the resolving list 211. In an embodiment of the disclosure, the processor 221, the memory 231, the display 261, and the communication circuitry 291 of FIG. 2A may correspond to the processor 120, the memory 130, the display module 160, and the communication module 190 of FIG. 1, respectively.

Referring to FIG. 2B, the external electronic device 102 may include a resolving list management unit 251, a data processing unit 252, the advertising module 253, the communication channel management unit 254, the message transmission/reception unit 255, and the MDE service 256. According to an embodiment of the disclosure, the external electronic device 102 may further include a cloud communication module (not illustrated) for communication with the server 108. For example, the external electronic device 102 may update the resolving list 211 via the cloud communication module (not illustrated) for communication with the server 108.

Hereinafter, among descriptions of the resolving list management unit 251, the data processing unit 252, the communication channel management unit 254, the message transmission/reception unit 255, and the MDE service 256, the description overlapping with the descriptions of the resolving list management unit 241, the data processing unit 242, the communication channel management unit 244, the message transmission/reception unit 245, the MDE service 246, and the cloud communication module 247 of the electronic device 101 may not be repeated.

In an embodiment of the disclosure, the resolving list management unit 251, the data processing unit 252, the advertising module 253, the communication channel management unit 254, the message transmission/reception unit 255, and the MDE service 256 may be programs that may be executed by the processor 221. In an embodiment of the disclosure, communication between the scan module 243, the communication channel management unit 254, the message transmission/reception unit 255, and the MDE service 256 of the external electronic device 102 and the advertising module 243, the communication channel management unit 244, the message transmission/reception unit 245, and the MDE service 246 of the electronic device 101 may be performed via the communication circuitry 291 of the external electronic device 102.

Operations described below may be performed by the external electronic device 102 based on the processor 221 executing instructions included in the resolving list management unit 251, the data processing unit 252, the advertising module 253, the communication channel management unit 254, the message transmission/reception unit 255, and the MDE service 256.

In an embodiment of the disclosure, the resolving list management unit 251 may manage the resolving list 211 of IRKs of one or more electronic devices linked with the user account logged (or registered) in the external electronic device 102.

In an embodiment of the disclosure, the data processing unit 252 may advertise the advertising packet (or the BLE ADV packet) via the advertising module 253. In an embodiment of the disclosure, the data processing unit 252 may transmit the advertising packet including the RPA of the external electronic device 102 to the electronic device 101. According to an embodiment of the disclosure, the data processing unit 252 may advertise the advertising packet including the version information of the resolving list 211.

In an embodiment of the disclosure, the advertising packet may include a preamble field, an access address field, a protocol data unit (PDU) field, and/or a cyclic redundancy check (CRC) field. In an embodiment of the disclosure, the access address field may include information on an advertising physical channel via which the advertising packet is transmitted. In an embodiment of the disclosure, the PDU field may include data of a variable length of 2 to 258 bytes. The PDU field may include a header field and a payload field. In an embodiment of the disclosure, the header field may include information indicating a type and a length of data included in the payload field. In an embodiment of the disclosure, the header field may include information (e.g., information indicated by TxAdd) indicating that the type of the data included in the payload field is advertising data. In an embodiment of the disclosure, the payload field may include data of a variable length of 1 to 255 bytes. In an embodiment of the disclosure, the payload field may include an advertising address (AdvA) field and an advertising data (AdvData) field. In an embodiment of the disclosure, the AdvA field may indicate an address (e.g., RPA) of the external electronic device 102 that has transmitted the advertising packet. In an embodiment of the disclosure, the AdvData field may include advertising data of 0 to 31 bytes. For example, the AdvData field may include at least one advertising data (AD) element. At least one AD element may include a length field, a type field, and a data field. However, it is not limited thereto. In an embodiment of the disclosure, the AdvData field may include a plurality of fields different from each other.

In an embodiment of the disclosure, the data processing unit 252 may receive a request for establishing a (temporary) communication channel with the external electronic device 102 from the electronic device 101 after transmitting the advertising packet including the RPA of the external electronic device 102 to the electronic device 101. In an embodiment of the disclosure, the request for establishing the communication channel may include the RPA of the external electronic device 102.

In an embodiment of the disclosure, the data processing unit 252 may establish the communication channel between the electronic device 101 and the external electronic device 102 by receiving information for the (temporary) communication channel from the electronic device 101 via the communication channel management unit 254.

In an embodiment of the disclosure, after establishing the (temporary) communication channel with the electronic device 101, the data processing unit 252 may receive a request for the version information of the resolving list 211 of the external electronic device 102 from the electronic device 101 via the message transmission/reception unit 255.

In an embodiment of the disclosure, the data processing unit 252 may transmit the version information of the resolving list 211 to the electronic device 101 via the message transmission/reception unit 255. In an embodiment of the disclosure, the data processing unit 252 may transmit the version information of the resolving list 211 to the electronic device 101 via the message transmission/reception unit 255 based on determining (or parsing) that the message received via the temporary communication channel from the electronic device 101 requests the version information of the resolving list 211.

In an embodiment of the disclosure, the data processing unit 252 may display, via the display 261, a user interface (UI) (e.g., UI 805 of FIG. 8B) for querying whether to share the version information of the resolving list 211 based on receiving the request for version information of the resolving list 211 of the external electronic device 102 from the electronic device 101 via the message transmission/reception unit 255. In an embodiment of the disclosure, the data processing unit 252 may obtain a user input regarding a UI querying whether to share the version information of the resolving list 211. In an embodiment of the disclosure, the data processing unit 252 may transmit, via the message transmission/reception unit 255, the version information of the resolving list 211 to the electronic device 101 based on determining that the user input regarding the UI indicates sharing of the version information of the resolving list 211.

In an embodiment of the disclosure, the data processing unit 252 may receive the request for sharing the resolving list 211 from the electronic device 101. In an embodiment of the disclosure, the data processing unit 252 may receive a request for sharing the resolving list 211 from the electronic device 101 via the message transmission/reception unit 255 after establishing the (temporary) communication channel with the electronic device 101.

In an embodiment of the disclosure, the data processing unit 252 may transmit the resolving list 211 to the electronic device 101 via the message transmission/reception unit 255. In an embodiment of the disclosure, the data processing unit 252 may transmit the resolving list 211 to the electronic device 101 via the message transmission/reception unit 255 based on determining (or parsing) that the message received via the temporary communication channel from the electronic device 101 requests the resolving list 211.

In an embodiment of the disclosure, the data processing unit 252 may receive a request for the MDE service 256 from the electronic device 101 based on the communication channel with the electronic device 101. In an embodiment of the disclosure, the data processing unit 252 may transmit a content of the request to the MDE service 256 based on receiving the request for the MDE service 256 from the electronic device 101.

Referring to FIG. 2A, the server 108 may include a processor 225, memory 235, and communication circuitry 295. In an embodiment of the disclosure, the memory 235 may include the resolving list 215.

For example, the server 108 may manage the resolving list 215 including a user account of the electronic device 101 and the external electronic device 102 and IRKs related to the user account.

Referring to FIG. 2B, the server 108 may include the cloud communication module 271. Among descriptions of the cloud communication module 271, a description overlapping the descriptions of the cloud communication module 247 of the electronic device 101 may not be repeated.

In an embodiment of the disclosure, the server 108 may receive a request for the resolving list 215 of newer version information from the electronic device 101 via the cloud communication module 271. In an embodiment of the disclosure, the server 108 may transmit the request for the resolving list 215 to the electronic device 101 via the cloud communication module 271 based on receiving the request for the resolving list 215.

As described above, the electronic device 101 may exclude identity information (or fingerprint) included in the advertising packet including the RPA that has failed to be resolved from the filter allow list. Accordingly, the electronic device 101 may prevent resolving of the advertising packet of the external electronic device 102 transmitting the RPA that has failed to be resolve.

In addition, as described above, in case that the resolving of the RPA fails, the electronic device 101 may determine whether to update the resolving list 210 stored in the electronic device 101 by obtaining the version information of the resolving list from the external electronic device 102. Accordingly, since the request for updating the resolving list transmitted by the electronic device 101 and the external electronic device 102 to the server 108 is decreased, burden and/or an overall network data usage of the server 108 may be decreased.

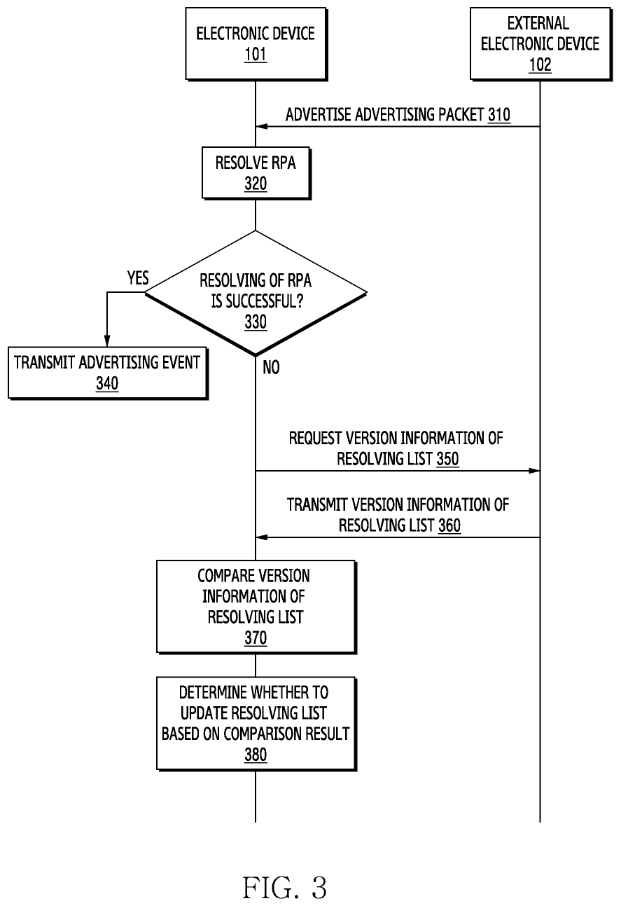

FIG. 3 is a flowchart indicating an operation in which an electronic device determines whether to update a resolving list according to an embodiment of the disclosure.

FIG. 3 may be described with reference to FIGS. 2A and 2B. Operations of FIG. 3 may be performed by the electronic device 101 and/or the external electronic device 102.

Referring to FIG. 3, in operation 310, the external electronic device 102 may advertise an advertising packet (or a BLE ADV packet). In an embodiment of the disclosure, the external electronic device 102 may transmit the advertising packet including an RPA of the external electronic device 102 to the electronic device 101. For example, the external electronic device 102 may broadcast an advertising packet including the RPA. According to an embodiment of the disclosure, the advertising packet may include version information of a resolving list 211. For example, the advertising packet may include a field for including the version information of the resolving list 211. Accordingly, by receiving the advertising packet including the field for including the version information of the resolving list 211, the electronic device 101 may confirm appearance of a new version of a resolving list 210 during message exchange with the external electronic device 102.

According to an embodiment of the disclosure, based on receiving the advertising packet including the version information of the resolving list 211, the electronic device 101 may compare the version information of the resolving list 210 with the version information of the resolving list 211. For example, in case that the version information of the resolving list 210 of the electronic device 101 indicates newer version information than the version information of the resolving list 211 received from the external electronic device 102, the electronic device 101 may transmit the resolving list 210 to the external electronic device 102. For example, in case that the version information of the resolving list 210 of the electronic device 101 indicates newer version information than the version information of the resolving list 211 received from the external electronic device 102, the electronic device 101 may transmit, to the external electronic device 102, a message inducing to update the resolving list 211 via a server 108.

According to an embodiment of the disclosure, the external electronic device 102 may advertise the advertising packet (or BLE ADV packet) including information indicating whether the version information of the resolving list 211 may be transmitted to the electronic device 101.

In operation 320, the electronic device 101 may resolve the RPA. For example, the electronic device 101 may obtain hash values for a prand of the RPA of the external electronic device 102 based on the IRKs included in the resolving list 210. For example, the electronic device 101 may compare the hash values for the prand of the RPA of the external electronic device 102 derived based on the IRK included in the resolving list 210 with a hash value corresponding to the hash value of the RPA of the external electronic device 102. For example, the electronic device 101 may identify whether there is the hash value corresponding to the hash value of the RPA of the external electronic device 102 among the hash values for the prand of the RPA of the external electronic device 102 derived based on the IRK included in the resolving list 210.

For example, the electronic device 101 may resolve the RPA of the external electronic device 102 included in the advertising packet based on identity information included in the advertising packet indicating a fingerprint (or fingerprinting information) of the electronic device 101 (or a user account of the electronic device 101). For example, the electronic device 101 may resolve the RPA of the external electronic device 102 included in the advertising packet based on the identity information included in the advertising packet being included in a filter allow list of the electronic device 101 (or the user account of the electronic device 101).

In operation 330, the electronic device 101 may determine whether the resolving of the RPA has been successful.

For example, the electronic device 101 may determine that the RPA of the external electronic device 102 is resolved based on identifying the hash value corresponding to the hash value of the RPA of the external electronic device 102 among the hash values for the prand of the RPA of the external electronic device 102 derived based on the IRK included in the resolving list 210. For example, the electronic device 101 may determine that the RPA of the external electronic device 102 is not resolved based on the fact that the hash value corresponding to the hash value of the RPA of the external electronic device 102 is not identified among the hash values for the prand of the RPA of the external electronic device 102 derived based on the IRK included in the resolving list 210.

In an embodiment of the disclosure, the electronic device 101 may perform operation 340 based on determining that resolving of the RPA has been successful. In an embodiment of the disclosure, the electronic device 101 may perform operation 350 based on determining that resolving of the RPA has failed.

In the operation 340, the electronic device 101 may transmit an advertising event to an MDE service 246. In an embodiment of the disclosure, the electronic device 101 may transmit a content of the advertising packet to the MDE service 246 as a portion of information included in the advertising event.

In the operation 350, the electronic device 101 may request version information of a resolving list from the external electronic device 102. In an embodiment of the disclosure, the external electronic device 102 may request version information of the resolving list 211 from the external electronic device 102 by using a (temporary) communication channel. According to an embodiment of the disclosure, in case (e.g., in case that the advertising packet transmitted in the operation 310 indicates that the version information of the resolving list 211 may not be transmitted) that the external electronic device 102 may not transmit the version information of the resolving list 211 to the electronic device 101, the electronic device 101 may request the server 108 for the version information of the resolving list.

In operation 360, the external electronic device 102 may transmit the version information of the resolving list to the electronic device 101. After the operation 360, the electronic device 101 may release a communication connection with the external electronic device 102. For example, the electronic device 101 may release the communication connection with the external electronic device 102 based on receiving the version information of the resolving list from the external electronic device 102. According to an embodiment of the disclosure, the electronic device 101 may receive the version information of the resolving list from the server 108.

In operation 370, the electronic device 101 may compare the version information of the resolving list. In an embodiment of the disclosure, the electronic device 101 may compare the version information of the resolving list 211 received from the external electronic device 102 with the version information of the resolving list 210 stored in the electronic device 101.

In operation 380, the electronic device 101 may determine whether to update the resolving list based on a comparison result. In an embodiment of the disclosure, the electronic device 101 may determine not to update the resolving list based on the version information of the resolving list 210 stored in the electronic device 101 indicating newer version information than the version information of the resolving list 211 from the external electronic device 102. In an embodiment of the disclosure, the electronic device 101 may determine to update the resolving list based on the version information of the resolving list 211 from the external electronic device 102 indicating newer version information than the version information of the resolving list 210 stored in the electronic device 101.

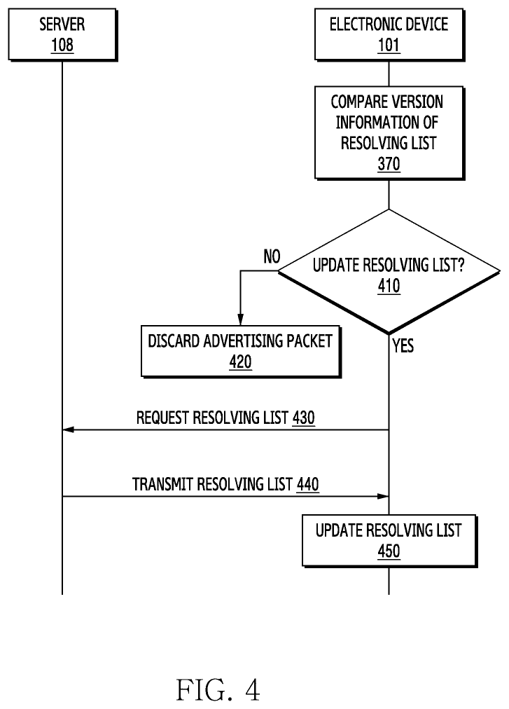

FIG. 4 is a flowchart indicating an operation in which an electronic device updates a resolving list according to an embodiment of the disclosure.

FIG. 4 may be described with reference to FIGS. 2A and 2B. Operations of FIG. 4 may be performed by an electronic device 101 and/or a server 108. Operation 370 of FIG. 4 may correspond to operation 370 of FIG. 3. Operations 410, 420, 430, 440 and 450 of FIG. 4 may correspond to operation 380 of FIG. 3.

Referring to FIG. 4, in the operation 370, the electronic device 101 may compare version information of the resolving list.

In operation 410, the electronic device 101 may determine whether to update the resolving list.

In an embodiment of the disclosure, the electronic device 101 may perform operation 420 based on determining not to update the resolving list. In an embodiment of the disclosure, the external electronic device 102 may perform operation 430 based on determining to update the resolving list.

According to an embodiment of the disclosure, in case that the electronic device 101 receives an advertising packet including version information of the resolving list 211 from the external electronic device 102, the electronic device 101 may determine whether to perform operation 430 based on the version information of the resolving list 211. For example, in case that the version information of the resolving list 211 included in the advertising packet received via the operation 310 of FIG. 3 indicates newer version information than the version information of a resolving list 210 of the electronic device 101, the electronic device 101 may perform the operation 430. For example, despite resolving of RPA being successful, in case that the version information of the resolving list 211 received from the external electronic device 102 indicates newer version information than the version information of the resolving list 210 of the electronic device 101, the electronic device 101 may perform operation 430.

In operation 420, the electronic device 101 may discard the advertising packet. According to an embodiment of the disclosure, the electronic device 101 may filter the advertising packet from the external electronic device 102 based on the version information of the resolving list 210 indicating newer version information than the version information of the resolving list 211. For example, filtering the advertising packet from the external electronic device 102 may include discarding the advertising packet received from the external electronic device 102 without resolving the advertising packet received from the external electronic device 102. For example, filtering the advertising packet from the external electronic device 102 may include excluding identity information included in the advertising packet of the external electronic device 102 from a filter allow list of the electronic device 101.

In operation 430, the electronic device 101 may request the server 108 for a resolving list 215. In an embodiment of the disclosure, the electronic device 101 may request the resolving list 215 of newer version information based on the version information of the resolving list 211 from the external electronic device 102 indicating newer version information than the version information of the resolving list 210 stored in the electronic device 101. In an embodiment of the disclosure, a request for the resolving list 215 of newer version information may include the version information of the resolving list 211 of the external electronic device 102.

In operation 440, the server 108 may transmit the resolving list 215 to the electronic device 101. In an embodiment of the disclosure, the server 108 may transmit the resolving list 215 of newer version information to the electronic device 101 via a cloud communication module 271. In an embodiment of the disclosure, the electronic device 101 may receive, from the server 108, via the cloud communication module 247, the resolving list 215 of version information corresponding to the version information of the resolving list 211 of the external electronic device 102.

In operation 450, the electronic device 101 may update the resolving list 210. In an embodiment of the disclosure, the electronic device 101 may update the resolving list 210 based on the resolving list 215 of newer version information from the server 108. In an embodiment of the disclosure, the electronic device 101 may replace the resolving list 210 with the resolving list 215 of newer version information from the server 108.

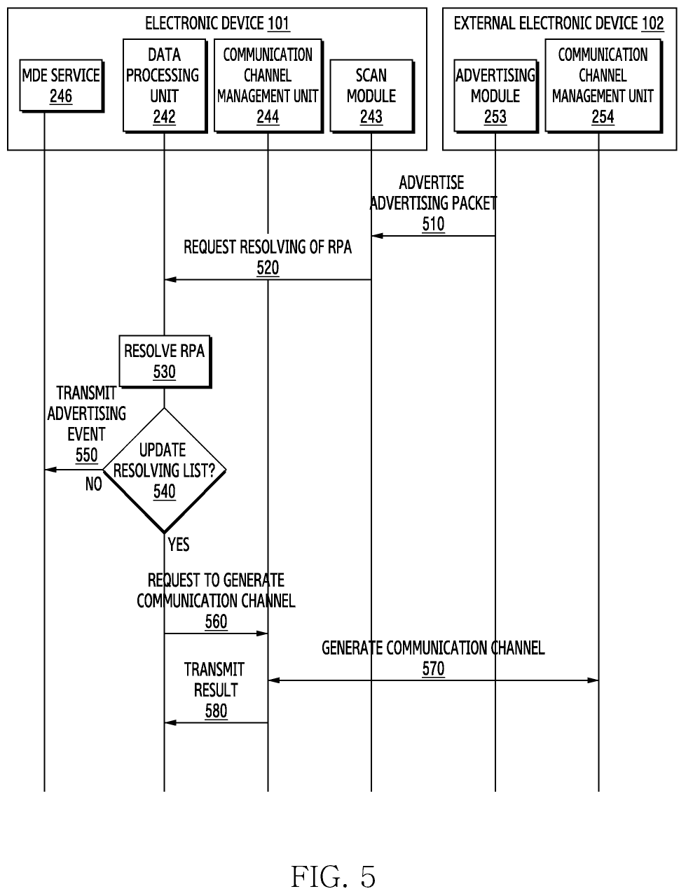

FIG. 5 is a flowchart indicating an operation in which an electronic device determines whether to update a resolving list according to an embodiment of the disclosure.

FIG. 5 may be described with reference to FIGS. 2A and 2B. Operations of FIG. 5 may be performed by an electronic device 101 and/or an external electronic device 102.

According to an embodiment of the disclosure, the electronic device 101 may include a data processing unit 242, a scan module 243, a communication channel management unit 244, and an MDE service 246.

According to an embodiment of the disclosure, the external electronic device 102 may include an advertising module 253 and a communication channel management unit 254.

Referring to FIG. 5, in operation 510, the advertising module 253 may advertise an advertising packet. In an embodiment of the disclosure, the advertising module 253 may advertise the advertising packet via communication circuitry 291. In an embodiment of the disclosure, the scan module 243 may receive the advertising packet from the advertising module 253. In an embodiment of the disclosure, the scan module 243 may receive the advertising packet from the advertising module 253 via communication circuitry 290.

In operation 520, the scan module 243 may request the data processing unit 242 to resolve an RPA. In an embodiment of the disclosure, the scan module 243 may transmit the advertising packet received from the advertising module 253 to the data processing unit 242.

In operation 530, the data processing unit 242 may resolve the RPA.

In an embodiment of the disclosure, the data processing unit 242 may identify the RPA of the external electronic device 102 included in the advertising packet. For example, the data processing unit 242 may identify the RPA of the external electronic device 102 included in the advertising packet based on identity information included in the advertising packet indicating a fingerprint of the electronic device 101 (or a user account of the electronic device 101).

In an embodiment of the disclosure, the data processing unit 242 may resolve the RPA of the external electronic device 102 based on IRKs included in the resolving list 210. For example, the data processing unit 242 may obtain hash values for a prand of the RPA of the external electronic device 102 based on the IRKs included in the resolving list 210. For example, the data processing unit 242 may compare the hash values for the prand of the RPA of the external electronic device 102 derived based on the IRK included in the resolving list 210 with a hash value corresponding to a hash value of the RPA of the external electronic device 102. For example, the data processing unit 242 may identify whether there is the hash value corresponding to the hash value of the RPA of the external electronic device 102 among the hash values for the prand of the RPA of the external electronic device 102 derived based on the IRK included in the resolving list 210.

For example, the data processing unit 242 may determine that the RPA of the external electronic device 102 is resolved based on identifying the hash value corresponding to the hash value of the RPA of the external electronic device 102 among the hash values for the prand of the RPA of the external electronic device 102 derived based on the IRK included in the resolving list 210. For example, the data processing unit 242 may determine that the RPA of the external electronic device 102 is not resolved based on the hash value corresponding to the hash value of the RPA of the external electronic device 102 not being identified among the hash values for the prand of the RPA of the external electronic device 102 derived based on the IRK included in the resolving list 210.

In operation 540, the data processing unit 242 may determine whether to update the resolving list 210.

In an embodiment of the disclosure, the data processing unit 242 may determine not to update the resolving list 210 based on determining that resolving of the RPA is successful. In an embodiment of the disclosure, the electronic device 101 may determine to update the resolving list 210 based on determining that resolving of the RPA has failed.

In an embodiment of the disclosure, the electronic device 101 may perform operation 560 based on determining to update the resolving list 210. In an embodiment of the disclosure, the electronic device 101 may perform operation 550 based on determining not to update the resolving list 210.

In operation 550, the data processing unit 242 may transmit an advertising event to the MDE service 246. In an embodiment of the disclosure, the MDE service 246 may perform an operation corresponding to the advertising event. For example, the operation corresponding to the advertising event may include notifying, indicating, or guiding a state of electronic device 101 to one or more devices (e.g., the external electronic device 102) around the electronic device 101. For example, the operation corresponding to the advertising event may include providing a user environment that integrates at least a portion of the capability of the electronic device 101 and at least a portion of the capability of the external electronic device 102. For example, the operation corresponding to the advertising event may include executing a software application executed in the electronic device 101 in the external electronic device 102 and maintaining an execution state of the software application in the electronic device 101 in the external electronic device 102. For example, the operation corresponding to the advertising event may include pasting text, an image, and/or a file copied (or stored) from the electronic device 101 to the clipboard in the external electronic device 102. For example, the operation corresponding to the advertising event may include transmitting an input to an input module (e.g., the input module 155 of FIG. 1) connected to the electronic device 101 to the external electronic device 102.

In an embodiment of the disclosure, the electronic device 101 may perform operation 560 to update the resolving list 210 based on determining that resolving of the RPA has failed. For example, the electronic device 101 may perform operation 560 to obtain version information of the resolving list 211 stored in the external electronic device 102 from the external electronic device 102.

In operation 560, the data processing unit 242 may request the communication channel management unit 244 to generate a communication channel. In an embodiment of the disclosure, the data processing unit 242 may transmit information (e.g., the RPA of the external electronic device 102) for establishing a (temporary) communication channel with the external electronic device 102 to the communication channel management unit 244.

In operation 570, the communication channel management unit 244 may generate a communication channel with the communication channel management unit 254. In an embodiment of the disclosure, the communication channel management unit 244 may establish a communication channel between the electronic device 101 and the external electronic device 102 by transmitting information (e.g., the RPA of the external electronic device 102) for establishing the communication channel to the communication channel management unit 254. In an embodiment of the disclosure, the communication channel management unit 244 may establish the communication channel between the electronic device 101 and the external electronic device 102 by transmitting the information (e.g., the RPA of the external electronic device 102) for establishing the communication channel to the communication channel management unit 254 via the communication circuitry 290.

For example, the communication channel may be a communication channel based on L2CAP by using the RPA of the external electronic device 102. However, it is not limited thereto. In addition, the communication channel may be a communication channel based on another communication protocol (e.g., Wi-Fi) other than BLE. For example, the communication channel management unit 244 may transmit information (e.g., Wi-Fi router information and/or an allocated IP address) for establishing a communication channel of another communication protocol other than BLE included in the advertising packet transmitted by the external electronic device 102.

In operation 580, the communication channel management unit 244 may transmit a result to the data processing unit 242. For example, the communication channel management unit 244 may transmit information to the data processing unit 242 indicating that the communication channel between the electronic device 101 and the external electronic device 102 is established.

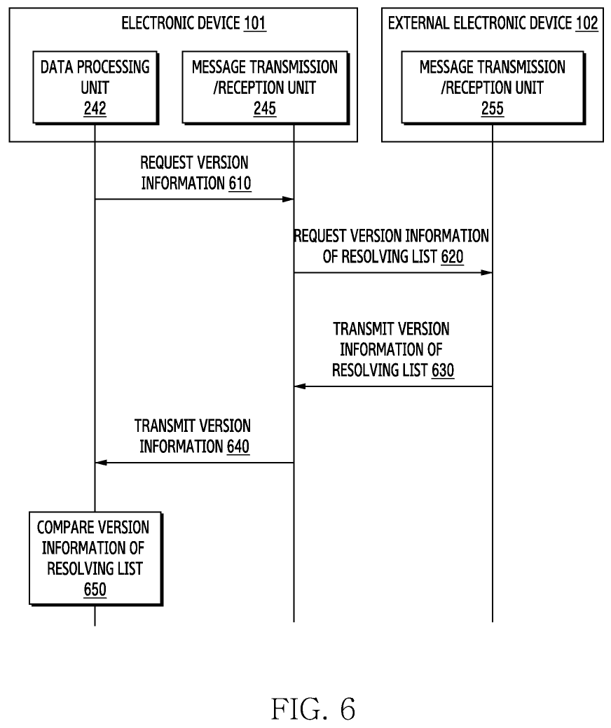

FIG. 6 is a flowchart indicating an operation in which an electronic device compares a version of a resolving list according to an embodiment of the disclosure.

FIG. 6 may be described with reference to FIGS. 2A and 2B. Operations of FIG. 6 may be performed by the electronic device 101 and/or the external electronic device 102.

According to an embodiment of the disclosure, the electronic device 101 may include a data processing unit 242 and a message transmission/reception unit 245.

According to an embodiment of the disclosure, the external electronic device 102 may include a message transmission/reception unit 255.

Referring to FIG. 6, in operation 610, the data processing unit 242 may request the message transmission/reception unit 245 for version information.

In operation 620, the message transmission/reception unit 245 may request the message transmission/reception unit 255 for version information of the resolving list. In an embodiment of the disclosure, the message transmission/reception unit 245 may request the message transmission/reception unit 255 for the version information of the resolving list via communication circuitry 290. In an embodiment of the disclosure, the message transmission/reception unit 245 may request the message transmission/reception unit 255 for version information of a resolving list 211 by using a communication channel (e.g., the communication channel established via the operations of FIG. 5) from the external electronic device 102.

In operation 630, the message transmission/reception unit 255 may transmit the version information of the resolving list 211 to the message transmission/reception unit 245. For example, the message transmission/reception unit 255 may transmit the version information of the resolving list 211 to the message transmission/reception unit 245 via communication circuitry 291.

In operation 640, the message transmission/reception unit 245 may transmit the version information of the resolving list 211 to the data processing unit 242.

In operation 650, the data processing unit 242 may compare version information of the resolving list. In an embodiment of the disclosure, the data processing unit 242 may compare the version information of the resolving list 211 with version information of a resolving list 210 stored in the electronic device 101.

In an embodiment of the disclosure, the data processing unit 242 may discard an advertising packet received from the external electronic device 102 based on the version information of the resolving list 210 stored in the electronic device 101 indicating newer version information than the version information of the resolving list 211. In an embodiment of the disclosure, the data processing unit 242 may filter the advertising packet from the external electronic device 102 based on the version information of the resolving list 210 indicating newer version information than the version information of the resolving list 211.

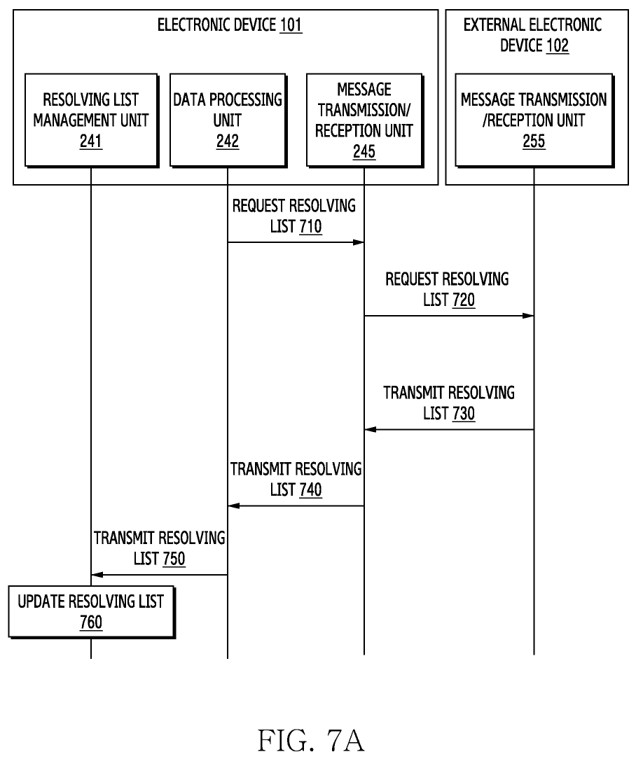

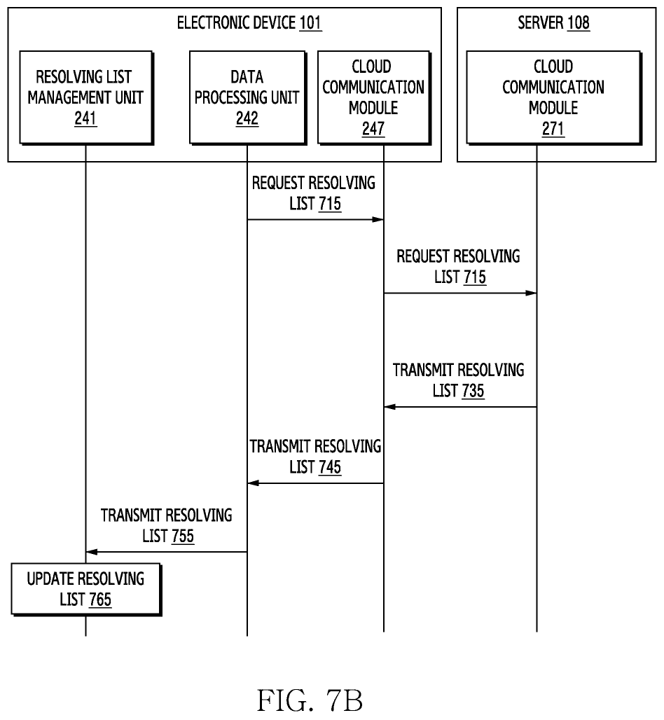

In an embodiment of the disclosure, the data processing unit 242 may perform operations of FIG. 7A based on the version information of the resolving list 211 from the external electronic device 102 indicating newer version information than the version information of the resolving list 210 stored in the electronic device 101.

FIG. 7A is a flowchart indicating an operation in which an electronic device updates a resolving list according to an embodiment of the disclosure.

FIG. 7A may be described with reference to FIGS. 2A and 2B. Operations of FIG. 7A may be performed by the electronic device 101 and/or the external electronic device 102.

According to an embodiment of the disclosure, the electronic device 101 may include a resolving list management unit 241, a data processing unit 242, and a message transmission/reception unit 245.

According to an embodiment of the disclosure, the external electronic device 102 may include a message transmission/reception unit 255.

Referring to FIG. 7A, in operation 710, the data processing unit 242 may request the message transmission/reception unit 245 for a resolving list 211.

In operation 720, the message transmission/reception unit 245 may request the message transmission/reception unit 255 for the resolving list 211. For example, the message transmission/reception unit 245 may request the message transmission/reception unit 255 for the resolving list 211 via communication circuitry 290.

In operation 730, the message transmission/reception unit 255 may transmit the resolving list 211 to the message transmission/reception unit 245. For example, the message transmission/reception unit 255 may transmit the resolving list 211 to the message transmission/reception unit 245 via communication circuitry 291.

In operation 740, the message transmission/reception unit 245 may transmit the resolving list 211 to the data processing unit 242. In operation 750, the data processing unit 242 may transmit the resolving list 211 to the resolving list management unit 241.

In operation 760, the resolving list management unit 241 may update the resolving list. In an embodiment of the disclosure, the resolving list management unit 241 may update a resolving list 210 based on the resolving list 211 from the external electronic device 102.

FIG. 7B is a flowchart illustrating an operation in which an electronic device updates a resolving list according to an embodiment of the disclosure.

FIG. 7B may be described referring to FIGS. 2A and 2B. Operations of FIG. 7B may be performed by an electronic device 101 and/or a server 108.

According to an embodiment of the disclosure, the electronic device 101 may include a resolving list management unit 241, a data processing unit 242, and a cloud communication module 247.

According to an embodiment of the disclosure, the server 108 may include a cloud communication module 271.

Referring to FIG. 7B, in operation 715, the data processing unit 242 may request the cloud communication module 247 for a resolving list 215.

In operation 725, the cloud communication module 247 may request the cloud communication module 271 the resolving list 215. For example, the cloud communication module 247 may request the cloud communication module 271 for the resolving list 215 via communication circuitry 290. In operation 735, the cloud communication module 271 may transmit the resolving list 215 to the cloud communication module 247. The cloud communication module 271 may transmit the resolving list 215 to the cloud communication module 247 via communication circuitry 295. In operation 745, the cloud communication module 247 may transmit the resolving list 215 to the data processing unit 242. In operation 755, the data processing unit 242 may transmit the resolving list 215 to the resolving list management unit 241.

In operation 765, the resolving list management unit 241 may update the resolving list. In an embodiment of the disclosure, the resolving list management unit 241 may update a resolving list 210 based on the resolving list 215 of newer version information from the server 108. In an embodiment of the disclosure, the resolving list management unit 241 may replace the resolving list 210 with the resolving list 215 of newer version information from the server 108.

FIG. 8A is a diagram illustrating a user interface (UI) querying an update of a resolving list displayed by an electronic device according to an embodiment of the disclosure.

Referring to FIG. 8A, a UI 801 may be displayed via a display 260 of an electronic device 101.

In an embodiment of the disclosure, the electronic device 101 may display the UI 801 querying whether to update a resolving list 210 via the display 260 based on determining that an RPA of an external electronic device 102 is not resolved.

In an embodiment of the disclosure, a data processing unit 242 may obtain a user input regarding the UI 801.

In an embodiment of the disclosure, the data processing unit 242 may perform operations for updating the resolving list 210 based on determining that the user input selects a visual object 811 of the UI 801 indicating the update of the resolving list 210.

In an embodiment of the disclosure, the data processing unit 242 may not perform operations for updating the resolving list 210 based on determining that the user input selects a visual object 815 of the UI 801 indicating that the resolving list 210 is not updated.

FIG. 8B is a diagram illustrating a UI querying whether to share information on a resolving list displayed by an electronic device according to an embodiment.

Referring to FIG. 8B, a UI 805 may be displayed via a display 261 of the external electronic device 102.

In an embodiment of the disclosure, the external electronic device 102 may display the UI 805 querying whether to share version information of a resolving list 211 via the display 261 based on receiving a request for the version information of the resolving list 211 of the external electronic device 102.

In an embodiment of the disclosure, the external electronic device 102 may obtain a user input regarding the UI 805.

In an embodiment of the disclosure, the external electronic device 102 may transmit the version information of the resolving list 211 to the electronic device 101 based on determining that the user input selects a visual object 821 of the UI 805 indicating sharing of the version information of the resolving list 211.

In an embodiment of the disclosure, the external electronic device 102 may not perform operations for transmitting the version information of the resolving list 211 to the electronic device 101 based on determining that a visual object 825 of the UI 805 indicating not to share the version information of the resolving list 211 is selected.

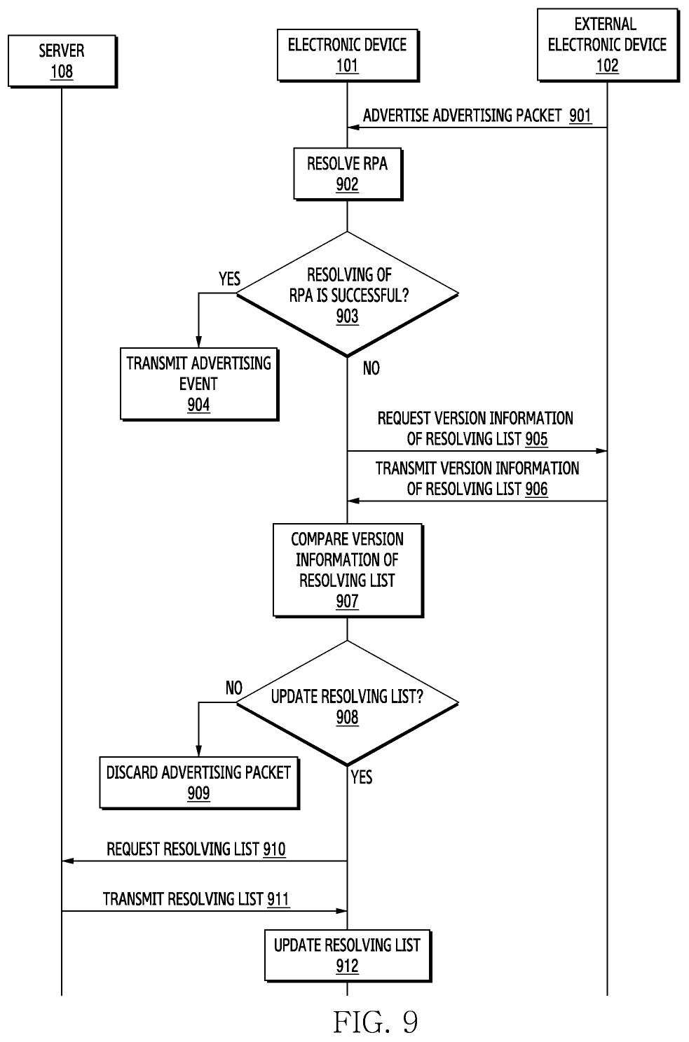

FIG. 9 is a flowchart indicating an operation in which an electronic device updates a resolving list according to an embodiment of the disclosure.

FIG. 9 may be described with reference to FIGS. 2A and 2B. Operations of FIG. 9 may be performed by the electronic device 101, the external electronic device 102, and/or a server 108.

Referring to FIG. 9, in operation 901, the external electronic device 102 may advertise an advertising packet (or a BLE ADV packet). In an embodiment of the disclosure, the external electronic device 102 may transmit an advertising packet including an RPA of the external electronic device 102 to the electronic device 101. For example, the external electronic device 102 may broadcast the advertising packet including the RPA. According to an embodiment of the disclosure, the advertising packet may include version information of a resolving list 211.

In operation 902, the electronic device 101 may resolve the RPA. For example, the electronic device 101 may obtain hash values for a prand of the RPA of the external electronic device 102 based on IRKs included in a resolving list 210. For example, the electronic device 101 may compare the hash values for the prand of the RPA of the external electronic device 102 derived based on the IRK included in the resolving list 210 with a hash value corresponding to the hash value of the RPA of the external electronic device 102. For example, the electronic device 101 may identify whether there is the hash value corresponding to the hash value of the RPA of the external electronic device 102 among the hash values for the prand of the RPA of the external electronic device 102 derived based on the IRK included in the resolving list 210.

For example, the electronic device 101 may resolve the RPA of the external electronic device 102 included in the advertising packet based on identity information included in the advertising packet indicating a fingerprint (or fingerprinting information) of the electronic device 101 (or a user account of the electronic device 101). For example, the electronic device 101 may resolve the RPA of the external electronic device 102 included in the advertising packet based on the identity information included in the advertising packet being included in a filter allow list of the electronic device 101 (or the user account of the electronic device 101).

In operation 903, the electronic device 101 may determine whether resolving of the RPA is successful.

For example, the electronic device 101 may determine that the RPA of the external electronic device 102 is resolved based on identifying the hash value corresponding to the hash value of the RPA of the external electronic device 102 among the hash values for the prand of the RPA of the external electronic device 102 derived based on the IRK included in the resolving list 210. For example, the electronic device 101 may determine that the RPA of the external electronic device 102 is not resolved based on the hash value corresponding to the hash value of the RPA of the external electronic device 102 not being identified among the hash values for the prand of the RPA of the external electronic device 102 derived based on the IRK included in the resolving list 210.

In an embodiment of the disclosure, the electronic device 101 may perform operation 904 based on determining that resolving of the RPA has been successful. In an embodiment of the disclosure, the electronic device 101 may perform operation 905 based on determining that resolving of the RPA has failed.

In operation 904, the electronic device 101 may transmit an advertising event to an MDE service 246. In an embodiment of the disclosure, the electronic device 101 may transmit a content of the advertising packet to the MDE service 246 as a portion of information included in the advertising event.

In operation 905, the electronic device 101 may request the version information of the resolving list from the external electronic device 102. In an embodiment of the disclosure, the external electronic device 102 may request the version information of the resolving list 211 from the external electronic device 102 using a (temporary) communication channel. In operation 906, the external electronic device 102 may transmit version information of the resolving list to the electronic device 101. After operation 906, the electronic device 101 may release a communication connection with the external electronic device 102. For example, the electronic device 101 may release the communication connection with the external electronic device 102 based on receiving the version information of the resolving list from the external electronic device 102.

In operation 907, the electronic device 101 may compare the version information of the resolving list. In an embodiment of the disclosure, the electronic device 101 may compare the version information of the resolving list 211 received from the external electronic device 102 with the version information of the resolving list 210 stored in the electronic device 101.

In operation 908, the electronic device 101 may determine whether to update the resolving list based on a comparison result. In an embodiment of the disclosure, the electronic device 101 may determine not to update the resolving list based on the version information of the resolving list 210 stored in the electronic device 101 indicating newer version information than the version information of the resolving list 211 from the external electronic device 102. In an embodiment of the disclosure, the electronic device 101 may determine to update the resolving list based on that the version information of the resolving list 211 from the external electronic device 102 indicating newer version information than the version information of the resolving list 210 stored in the electronic device 101.

In an embodiment of the disclosure, the electronic device 101 may perform operation 909 based on determining not to update the resolving list. In an embodiment of the disclosure, the external electronic device 102 may perform operation 910 based on determining to update the resolving list.

In operation 909, the electronic device 101 may discard the advertising packet. According to an embodiment of the disclosure, the electronic device 101 may filter the advertising packet from the external electronic device 102 based on the version information of the resolving list 210 indicating newer version information than the version information of the resolving list 211. For example, filtering the advertising packet from the external electronic device 102 may include discarding the advertising packet received from the external electronic device 102 without resolving the advertising packet received from the external electronic device 102. For example, filtering the advertising packet from the external electronic device 102 may include excluding the identity information included in the advertising packet of the external electronic device 102 from the filter allow list of the electronic device 101.

In operation 910, the electronic device 101 may request the server 108 for the resolving list 215. In an embodiment of the disclosure, the electronic device 101 may request the resolving list 215 of newer version information based on the version information of the resolving list 211 from the external electronic device 102 indicating newer version information than the version information of the resolving list 210 stored in the electronic device 101. In an embodiment of the disclosure, the request of the resolving list 215 of newer version information may include the version information of the resolving list 211 of the external electronic device 102.

In operation 911, the server 108 may transmit the resolving list 215 to the electronic device 101. In an embodiment of the disclosure, the server 108 may transmit the resolving list 215 of newer version information to the electronic device 101 via a cloud communication module 271. In an embodiment of the disclosure, the electronic device 101 may receive, from the server 108, via a cloud communication module 247, the resolving list 215 of version information corresponding to the version information of the resolving list 211 of the external electronic device 102.

In operation 912, the electronic device 101 may update the resolving list 210. In an embodiment of the disclosure, the electronic device 101 may update the resolving list 210 based on the resolving list 215 of newer version information from the server 108. In an embodiment of the disclosure, the electronic device 101 may replace the resolving list 210 with the resolving list 215 of newer version information from the server 108.

As described above, an electronic device 101 may comprise communication circuitry 290, at least one processor 120 comprising processing circuitry, and memory 130, comprising one or more storage mediums, storing instructions. The instructions, when executed by the at least one processor 120 individually or collectively, may cause the electronic device 101 to receive, via the communication circuitry 290, an advertising packet advertised from the external electronic device 102. The instructions, when executed by the at least one processor 120 individually or collectively, may cause the electronic device 101 to determine, based on a first list 210 of identity resolving keys (IRKs) of other electronic devices, whether a resolvable private address (RPA) of the external electronic device 102 in the advertising packet is resolved. The instructions, when executed by the at least one processor 120 individually or collectively, may cause the electronic device 101 to, based on determining that the RPA of the external electronic device 102 is not resolved, request, from the external electronic device 102, via the communication circuitry 290, a version of a second list 211 of IRKs.

The instructions, when executed by the at least one processor 120 individually or collectively, may cause the electronic device 101 to receive, from the external electronic device 102, via the communication circuitry 290, the version of the second list 211 of IRKs. The instructions, when executed by the at least one processor 120 individually or collectively, may cause the electronic device 101 to compare the version of the second list 211 of IRKs from the external electronic device 102 with a version of the first list 210 of IRKs in the electronic device 101. The instructions, when executed by the at least one processor 120 individually or collectively, may cause the electronic device 101 to, based on determining that the version of the second list 211 of IRKs from the external electronic device 102 is newer version than the version of the first list 210 of IRKs in the electronic device 101, request, from a server 108, via the communication circuitry 290, a third list 215 of IRKs associated with a user account of the electronic device 101, receive, from the server 108, via the communication circuitry 290, the third list 215 of IRKs associated with the user account, and update the first list 210 of IRKs in the electronic device 101, based on the third list 215 of IRKs associated with the user account received from the server 108.

The instructions, when executed by the at least one processor 120 individually or collectively, may cause the electronic device 101 to receive, via the communication circuitry 290, another advertising packet including the RPA advertised from the external electronic device 102. The instructions, when executed by the at least one processor 120 individually or collectively, may cause the electronic device 101 to determine, based on the updated first list 210 of IRKs, whether the RPA included in the another advertising packet is resolved.

The instructions, when executed by the at least one processor 120 individually or collectively, may cause the electronic device 101 to, based on determining that the RPA included in the advertising packet is not resolved, store temporarily the advertising packet in the memory 130, and determine, based on the updated first list 210 of IRKs, whether the RPA included in the advertising packet stored temporarily in the memory 130 is resolved.

The instructions, when executed by the at least one processor 120 individually or collectively, may cause the electronic device 101 to identify fingerprinting information from the advertising packet. The instructions, when executed by the at least one processor 120 individually or collectively, may cause the electronic device 101 to, based on determining that the fingerprinting information is included in a filter allow list, determine whether the RPA included in the advertising packet is resolved.

The instructions, when executed by the at least one processor 120 individually or collectively, may cause the electronic device 101 to, based on determining that the fingerprinting information is not included in the filter allow list, discard the advertising packet without resolving the RPA included in the advertising packet.

The instructions, when executed by the at least one processor 120 individually or collectively, may cause the electronic device 101 to, based on determining that the RPA included in the advertising packet is not resolved, decrypt a payload included in the advertising packet, determine whether the decrypted payload includes data with a designated format, and based on determining that the decrypted payload includes the data with the designated format, request, from the external electronic device 102, via the communication circuitry 290, the version of the first list 210 of IRKs.

The instructions, when executed by the at least one processor 120 individually or collectively, may cause the electronic device 101 to, based on determining that the decrypted payload does not include the data with the designated format, discard the advertising packet without requesting the version of the second list 211 of IRKs.

As described above, the electronic device 101 may comprise a display 260. The instructions, when executed by the at least one processor 120 individually or collectively, may cause the electronic device 101 to, based on determining that the RPA included in the advertising packet is not resolved, display, via the display 260, a user interface (UI) 801 for querying whether to update the first list 210 of IRKs, and in response to a user input regarding the UI, request, from the external electronic device 102, via the communication circuitry 290, the version of the second list 211 of IRKs.

The instructions, when executed by the at least one processor 120 individually or collectively, may cause the electronic device 101 to receive, from the external electronic device 102, via the communication circuitry 290, the version of the second list 211 of IRKs. The instructions, when executed by the at least one processor 120 individually or collectively, may cause the electronic device 101 to compare the version of the second list 211 of IRKs from the external electronic device 102, with a version of the first list 210 of IRKs in the electronic device 101. The instructions, when executed by the at least one processor 120 individually or collectively, may cause the electronic device 101 to, based on determining that the version of the second list 211 of IRKs from the external electronic device 102 is newer version than the version of the first list 210 of IRKs in the electronic device 101, request, from the external electronic device 102, via the communication circuitry 290, the second list 211 of IRKs, receive, from the external electronic device 102, via the communication circuitry 290, the second list 211 of IRKs, and based on the second list 211 of IRKs from the external electronic device 102, update the first list 210 of IRKs in the electronic device 101.

As described above, a method may be performed by an electronic device 101 including communication circuitry 290. The method may comprise receiving, via the communication circuitry 290, an advertising packet advertised from the external electronic device 102. The method may comprise determining, based on a first list 210 of identity resolving keys (IRKs) of other electronic devices, whether a resolvable private address (RPA) of the external electronic device 102 in the advertising packet is resolved. The method may comprise, based on determining that the RPA of the external electronic device 102 is not resolved, requesting, from the external electronic device 102, via the communication circuitry 290, a version of the second list 211 of IRKs.

The method may comprise receiving the version of the second list 211 of IRKs from the external electronic device 102, via the communication circuitry 290. The method may comprise comparing the version of the second list 211 of IRKs from the external electronic device 102, with a version of the second list 211 of IRKs in the electronic device 101. The method may comprise, based on determining that the version of the second list 211 of IRKs from the external electronic device 102 is newer version than the version of the first list 210 of IRKs in the electronic device 101, requesting, from a server 108, via the communication circuitry 290, a third list 215 of IRKs associated with a user account of the electronic device 101, receiving, from the server 108, via the communication circuitry 290, the third list 215 of IRKs associated with the user account, and updating the list 210 of IRKs in the electronic device 101 based on the third list 215 of IRKs associated with the user account received from the server 108.

The method may comprise receiving, via the communication circuitry 290, another advertising packet including the RPA advertised from the external electronic device 102. The method may comprise determining, based on the updated first list 210 of IRKs, whether the RPA included in the another advertising packet is resolved.

The method may comprise, based on determining that the RPA included in the advertising packet is not resolved, storing temporarily the advertising packet in the memory 130, and determining, based on the updated first list 210 of IRKs, whether the RPA included in the advertising packet stored temporarily in the memory 130 is resolved.

The method may comprise identifying fingerprinting information from the advertising packet. The method may comprise, based on determining that the fingerprinting information is included in a filter allow list, determining whether the RPA included in the advertising packet is resolved.

The method may comprise, based on determining that the fingerprinting information is not included in the filter allow list, discarding the advertising packet without resolving the RPA included in the advertising packet.

The method may comprise, based on determining that the RPA included in the advertising packet is not resolved, decrypting a payload included in the advertising packet, determining whether the decrypted payload includes data with a designated format, and based on determining that the decrypted payload includes the data with the designated format, requesting, from the external electronic device 102, via the communication circuitry 290, the version of the first list 210 of IRKs.

The method may comprise, based on determining that the decrypted payload does not include the data with the designated format, discarding the advertising packet without requesting the version of the second list 211 of IRKs.

The method may comprise, based on determining that the RPA included in the advertising packet is not resolved, displaying, via a display 260, a user interface (UI) 801 for querying whether to update the first list 210 of IRKs, and in response to a user input regarding the UI, requesting, from the external electronic device 102, via the communication circuitry 290, the version of the second list 211 of IRKs.

The method may comprise receiving, from the external electronic device 102, via the communication circuitry 290, the version of the second list 211 of IRKs. The method may comprise comparing the version of the first list of 210 IRKs from the external electronic device 102, with a version of the first list 210 of IRKs in the electronic device 101. The method may comprise, based on determining that the version of the second list 211 of IRKs from the external electronic device 102 is newer version than the version of the first list 210 of IRKs in the electronic device 101, requesting, from external electronic device 102, via the communication circuitry 290, the second list 211 of IRKs, receiving, from the external electronic device 102, via the communication circuitry 290, the second list 211 of IRKs, and updating the first list 210 of IRKs in the electronic device 101 based on the second list 211 of IRKs from the external electronic device 102.

The method may comprise based on determining that the RPA of the external electronic device is resolved, transmitting a content of the advertising packet to a multi-device experience (MDE) service.

The method may comprise based on transmitting the content of the advertising packet to the MDE service, providing a continuation service, a sharing service, and/or a quick sharing service to a user.

As described above, a non-transitory computer readable storage medium may store a program including instructions. The instructions, when executed by at least one processor 120 of an electronic device 101 including communication circuitry 290 individually or collectively, may cause the electronic device 101 to receive, via the communication circuitry 290, an advertising packet advertised from the external electronic device 102. The instructions, when executed by the at least one processor individually or collectively, may cause the electronic device 101 to determine, based on a first list 210 of identity resolving keys (IRKs) of other electronic devices whether a resolvable private address (RPA) of the external electronic device 102 in the advertising packet is resolved. The instructions, when executed by the at least one processor 120 individually or collectively, may cause the electronic device 101 to, based on determining that the RPA of the external electronic device 102 is not resolved, request, from the external electronic device 102, via the communication circuitry 290, a version of a second list 211 of IRKs.

As described above, one or more non-transitory computer-readable storage media may store one or more computer programs including computer-executable instructions that, when executed by one or more processors of an electronic device including communication circuitry individually or collectively, cause the electronic device to perform operations. The operations comprises: receiving, via the communication circuitry, an advertising packet advertised from an external electronic device; determining, based on a first list of identity resolving keys (IRKs) of other electronic devices, whether a resolvable private address (RPA) of the external electronic device in the advertising packet is resolved; and based on determining that the RPA of the external electronic device is not resolved, requesting, from the external electronic device, via the communication circuitry, a version of a second list of IRKs.

The one or more non-transitory computer-readable storage media further comprises computer-executable instructions that, when executed by one or more processors of an electronic device including communication circuitry individually or collectively, cause the electronic device to receive, from the external electronic device, via the communication circuitry, the version of the list of IRKs, compare the version of the second list of IRKs from the external electronic device, with a version of the first list of IRKs in the electronic device, based on determining that the version of the second list of IRKs from the external electronic device is newer version than the version of the first list of IRKs in the electronic device, request, from a server, via the communication circuitry, a third list of IRKs associated with a user account of the electronic device, receiving, from the server, via the communication circuitry, the third list of IRKs associated with the user account, and update the first list of IRKs in the electronic device, based on the third list of IRKs associated with the user account received from the server.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
at least one processor comprising processing circuitry; and
memory, comprising one or more storage mediums, storing instructions,
wherein the instructions, when executed by the at least one processor individually or collectively, cause the electronic device to:
receive, via the communication circuitry, an advertising packet advertised from an external electronic device,
determine, based on a first list of identity resolving keys (IRKs) of other electronic devices whether a resolvable private address (RPA) of the external electronic device in the advertising packet is resolved, and
based on determining that the RPA of the external electronic device is not resolved, request, from the external electronic device, via the communication circuitry, a version of a second list of IRKs.

2. The electronic device of claim 1, wherein the instructions, when executed by the at least one processor individually or collectively, further cause the electronic device to:
receive, from the external electronic device, via the communication circuitry, the version of the second list of IRKs,
compare the version of the second list of IRKs from the external electronic device, with a version of the first list of IRKs in the electronic device, and
based on determining that the version of the second list of IRKs from the external electronic device is newer version than the version of the first list of IRKs in the electronic device:
request, from a server, via the communication circuitry, a third list of IRKs associated with a user account of the electronic device,
receive, from the server, via the communication circuitry, the third list of IRKs associated with the user account, and
update the first list of IRKs in the electronic device, based on the third list of IRKs associated with the user account received from the server.

3. The electronic device of claim 2, wherein the instructions, when executed by the at least one processor individually or collectively, further cause the electronic device to:
receive, via the communication circuitry, another advertising packet including the RPA advertised from the external electronic device, and
determine, based on the updated first list of IRKs, whether the RPA included in the another advertising packet is resolved.

4. The electronic device of claim 2, wherein the instructions, when executed by the at least one processor individually or collectively, further cause the electronic device to:
based on determining that the RPA included in the advertising packet is not resolved:
store temporarily the advertising packet in the memory, and
determine, based on the updated first list of IRKs, whether the RPA included in the advertising packet stored temporarily in the memory is resolved.

5. The electronic device of claim 1, wherein the instructions, when executed by the at least one processor individually or collectively, further cause the electronic device to:
identify fingerprinting information from the advertising packet, and
based on determining that the fingerprinting information is included in a filter allow list, determine whether the RPA included in the advertising packet is resolved.

6. The electronic device of claim 5, wherein the instructions, when executed by the at least one processor individually or collectively, further cause the electronic device to:
based on determining that the fingerprinting information is not included in the filter allow list, discard the advertising packet without resolving the RPA included in the advertising packet.

7. The electronic device of claim 1, wherein the instructions, when executed by the at least one processor individually or collectively, further cause the electronic device to:
based on determining that the RPA included in the advertising packet is not resolved:
decrypt a payload included in the advertising packet, and
determine whether the decrypted payload includes data with a designated format, and
based on determining that the decrypted payload includes the data with the designated format, request, from the external electronic device, via the communication circuitry, the version of the first list of IRKs.

8. The electronic device of claim 7, wherein the instructions, when executed by the at least one processor individually or collectively, further cause the electronic device to:
based on determining that the decrypted payload does not include the data with the designated format, discard the advertising packet without requesting the version of the second list of IRKs.

9. The electronic device of claim 1, further comprising:
a display,
wherein the instructions, when executed by the at least one processor individually or collectively, further cause the electronic device to:
based on determining that the RPA included in the advertising packet is not resolved:
display, via the display, a user interface (UI) for querying whether to update the first list of IRKs, and
in response to a user input regarding the UI, request, from the external electronic device, via the communication circuitry, the version of the second list of IRKs.

10. The electronic device of claim 1, wherein the instructions, when executed by the at least one processor individually or collectively, further cause the electronic device to:
receive, from the external electronic device, via the communication circuitry, the version of the second list of IRKs,
compare the version of the second list of IRKs from the external electronic device, with a version of the first list of IRKs in the electronic device, and
based on determining that the version of the second list of IRKs from the external electronic device is newer version than the version of the first list of IRKs in the electronic device:
request, from the external electronic device, via the communication circuitry, the second list of IRKs,
receive, from the external electronic device, via the communication circuitry, the second list of IRKs, and
update the first list of IRKs in the electronic device, based on the second list of IRKs from the external electronic device.

11. A method performed by an electronic device including communication circuitry, the method comprising:
receiving, via the communication circuitry, an advertising packet advertised from an external electronic device;
determining, based on a first list of identity resolving keys (IRKs) of other electronic devices, whether a resolvable private address (RPA) of the external electronic device in the advertising packet is resolved; and
based on determining that the RPA of the external electronic device is not resolved, requesting, from the external electronic device, via the communication circuitry, a version of a second list of IRKs.

12. The method of claim 11, further comprising:
receiving, from the external electronic device, via the communication circuitry, the version of the list of IRKs;
comparing the version of the second list of IRKs from the external electronic device, with a version of the first list of IRKs in the electronic device; and
based on determining that the version of the second list of IRKs from the external electronic device is newer version than the version of the first list of IRKs in the electronic device:
requesting, from a server, via the communication circuitry, a third list of IRKs associated with a user account of the electronic device,
receiving, from the server, via the communication circuitry, the third list of IRKs associated with the user account, and
updating the first list of IRKs in the electronic device, based on the third list of IRKs associated with the user account received from the server.

13. The method of claim 12, further comprising:
receiving, via the communication circuitry, another advertising packet including the RPA advertised from the external electronic device; and
determining, based on the updated first list of IRKs, whether the RPA included in the another advertising packet is resolved.

14. The method of claim 12, further comprising:
based on determining that the RPA included in the advertising packet is not resolved:
storing temporarily the advertising packet in memory, and
determining, based on the updated list of IRKs, whether the RPA included in the advertising packet stored temporarily in the memory is resolved.

15. The method of claim 11, further comprising:
identifying fingerprinting information from the advertising packet; and
based on determining that the fingerprinting information is included in a filter allow list, determining whether the RPA included in the advertising packet is resolved.

16. The method of claim 15, further comprising:
based on determining that the fingerprinting information is not included in the filter allow list, discarding the advertising packet without resolving the RPA included in the advertising packet.

17. The method of claim 11, further comprising:
based on determining that the RPA included in the advertising packet is not resolved:
decrypting a payload included in the advertising packet, and
determining whether the decrypted payload includes data with a designated format, and
based on determining that the decrypted payload includes the data with the designated format, requesting, from the external electronic device, via the communication circuitry, the version of the first list of IRKs.

18. The method of claim 17, further comprising:
based on determining that the decrypted payload does not include the data with the designated format, discarding the advertising packet without requesting the version of the second list of IRKs.

19. The method of claim 11, further comprising:
based on determining that the RPA included in the advertising packet is not resolved:
displaying, via a display, a user interface (UI) for querying whether to update the first list of IRKs, and
in response to a user input regarding the UI, requesting, from the external electronic device, via the communication circuitry, the version of the second list of IRKs.

20. The method of claim 11, further comprising:
receiving, from the external electronic device, via the communication circuitry, the version of the second list of IRKs;
comparing the version of the first list of IRKs from the external electronic device, with a version of the first list of IRKs in the electronic device; and
based on determining that the version of the second list of IRKs from the external electronic device is newer version than the version of the first list of IRKs in the electronic device:
requesting, from the external electronic device, via the communication circuitry, the second list of IRKs,
receiving, from the external electronic device, via the communication circuitry, the second list of IRKs, and
updating the first list of IRKs in the electronic device, based on the second list of IRKs from the external electronic device.
